(19) United States
(12) Patent Application Publication
(10) Pub. No.: US 2011/0231772 A1
(43) Pub. Date: Sep. 22, 2011

(54) Systems and Methods for Mediating Internet Access According to a Schedule

(76) Inventor: Tom C. Tovar, San Francisco, CA (US)

(21) Appl. No.: 12/897,703

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 3/01; G06F 15/16

(52) U.S. Cl. 715/736; 709/225

(57) ABSTRACT

Systems and methods to mediate Internet content to a user are disclosed. Embodiments of the disclosed systems and methods may operate on a network and block or restrict a user's access to the Internet according to a temporal schedule. Embodiments of the present invention may be implemented at the network, server, or local level.

### CROSS REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### BACKGROUND OF THE INVENTION

1. Field of the Invention

The present invention relates generally to mediating Internet service. The present invention relates more particularly to systems and methods to mediate Internet service over a network to a user by regulating access based on a temporal schedule.

2. Background

Since the Internet was launched in 1995, the Internet has grown to become an instantly-searchable, vast repository of information on almost every topic imaginable. As a result, users can indulge their every curiosity by accessing content at any time. Further, the Internet offers nearly limitless opportunity for creative users to create and distribute content, such as blogs, artwork, photography, creative writing, or scholarly, research or reference articles. Additionally, the Internet serves as a platform for thousands of online games, in which users can become players in expansive, elaborate games that approximate an alternative reality.

As a result of these developments, the Internet can engage users' attention and time to a very significant degree, perhaps at the expense of other worthwhile endeavors. Users may spend, and perhaps waste, hours browsing the Internet with no particular goal, following links as curiosity leads. Video sites such as YouTube offer seemingly limitless distraction for some. Others spend hours and even days engrossed in online gaming. Although these may represent extreme cases, many users of the Internet can relate to spending too much time online to the detriment of their relationships.

This is true in part because Internet usage is primarily a personal, i.e. individual, pursuit. To the extent group engagements exist on the Internet, they are designed to bring collections of physically separated individuals together online. Therefore, Internet usage does not generally encourage, and may impede, real physical interpersonal interaction. This may be particularly true in the case of couples, where excessive Internet usage may interfere with intimacy and compete for time and energy that would otherwise be spent together.

### SUMMARY OF THE INVENTION

Embodiments of the present invention provide systems and methods for mediating Internet usage at preset times and for a preset duration. Embodiments of the present invention comprise Internet utilities that allow Internet users to schedule interpersonal commitments to spend time with other people, such as friends, family, children, or partners, rather than online. For example, embodiments of the present invention may be used to provide substance to, reinforce, or provide a mechanism for facilitating, agreements or commitments between people to spend time together.

In some embodiments, the present invention may be used to block all Internet access for at a preset time and for a present duration. In other embodiments, the disclosed utilities may block most Internet access but allow access to some websites, such as those providing content that may be enjoyed together, and may therefore be used to facilitate the growth or maintenance of a relationship, such as movie or music websites. As used herein, mediating Internet access may include any of blocking, constraining, enabling, redirecting, promoting, demoting, substituting, obscuring, limiting, interrupting, and restricting all or a portion of the Internet service.

The Internet mediation functionality provided by embodiments of the disclosed utilities may be scheduled by a user by designating the time or times when the mediation functionality should take effect, and in some embodiments, the duration of any mediation selected. In some embodiments, mediation may be designated by a user for engagement according to a periodic schedule, such as daily, weekly, monthly, or annually, or on special occasions like birthdays, anniversaries, or holidays. For example, a couple desiring to spend more time together may determine when to plan an interpersonal commitment and schedule it on a recurring basis in their electronic calendars. They may then program the mediation functionality of the disclosed systems to block Internet access during these times.

Embodiments of the present invention may prevent users from accessing the Internet or Internet-enabled communication services, such content through the users' web browsers. Embodiments of the present invention may mediate any network connectivity that could potentially interfere with a relationship. For example, embodiments of the present invention may block connectivity of VoIP services, chat services, video chat services or meeting and conferencing services. Embodiments of the present invention may be deployed on mobile devices to mediate Internet access.

For purposes of this disclosure, the definition of “Internet service provider” will include any service or technology that provides a connection to the Internet. Examples of such technologies include, but are not limited to, traditional Internet service providers, telecommunications companies, cable operators, mobile operators, network operators and any other provider of wired or wireless access to Internet services. All such services are herein referred to as “ISPs.”

Embodiments of the disclosed invention may be used with the full range of user devices capable of accessing and displaying content from the Internet. User devices can display content to the user via a user interface, such as a web page, for example an html web page displayable in an Internet browser. User devices may include desktop computers, tablets, PCs, laptops, Smartphones, notebooks, game consoles (e.g., an X-box), iPods, iPhones and Internet enabled TVs. The system may also be deployed, accessed, and controlled through mobile devices, such as a smartphone. A smartphone can be generally defined as a phone with computing capability. A smartphone can provide Internet access to a user.

### BRIEF DESCRIPTION OF THE DRAWINGS

FIG. 1 is a block diagram of components of an exemplary system in accordance with embodiments of the present invention.

FIG. 2 is a block diagram of components of a further exemplary system in accordance with embodiments of the present invention.

FIG. 3 is a block flow diagram of an exemplary method in accordance with embodiments of the present invention.

FIG. 4 is block flow diagram of a further exemplary method in accordance with embodiments of the present invention.

FIG. 5 is a block flow diagram of a further exemplary method in accordance with embodiments of the present invention.

FIG. 6 is a screenshot of an exemplary user interface in accordance with embodiments of the present invention.

FIG. 7 is a screenshot of a further exemplary user interface in accordance with embodiments of the present invention.

FIG. 8 is a block diagram of components of an exemplary system in accordance with embodiments of the present invention.

FIG. 9 is a block diagram of components of a further exemplary system in accordance with embodiments of the present invention.

FIG. 10 is a block diagram of components of a further exemplary system in accordance with embodiments of the present invention.

### DETAILED DESCRIPTION

Embodiments of the present invention may be implemented at the network, domain, or DNS (Domain Name System) level, and at the local application level. Embodiments may mediate a user request to resolve an Internet address at various communication layers, such as at the application layer. Various embodiments of the disclosed invention may be used to mediate Internet content by domain name. Embodiments of the present invention may be deployed or implemented at the server level. For example, embodiments of the present invention may offer network-level service interruption to users.

Exemplary systems of the disclosed technology may have one or more functional components. For example, some embodiments may have one or more dynamic enforcement engines to mediate access to the Internet, such as via a DNS server. The dynamic enforcement engines may implement one or more schedules for determining whether and when to allow a user access to the Internet through a user device. Schedules may include a temporal schedule for mediating access. Exemplary embodiments of the disclosed systems may have one or more policy modules in communication with the dynamic enforcement engines. The policy modules may maintain and provide the schedules data to the dynamic enforcement engines.

Exemplary user devices for use with the disclosed systems may have a user interface. In various embodiments, such as those deployed on personal mobile devices, the user interface may be, or may execute, an application, such as a mobile application (hereinafter referred to as a “app”). A app may be downloaded and installed on a user's mobile device. Users may define the schedules via a user device, such as through the user interface. Some embodiments of the present invention do not require software to be downloaded or installed locally to the user device and, correspondingly, do not require the user to execute a de-install application to cease use of the system.

Generally speaking, an administrator may create and enforce value-based mediation polices, a schedule for instance, for one or more end users that utilize computing devices coupled to an Internet service delivered to a location such as a home, residence or place of business or campus. The term “administrator” may include not only individuals, such as parents, but also any individual creating a mediation policies regarding the Internet service delivered to end users. It will be understood that an administrator may also be an end user, although end users who are not also administrators may not create or apply mediation policies.

It will be further understood that because of the diversity of computing devices that may connect to the Internet service, the mediation policy may be applied to the Internet service rather than requiring the mediation policy to affect each computing device individually, such as a mediation application resident on each computing device. In various exemplary embodiments a mediation policy may also reside as a stand alone application on one or more of the computing devices.

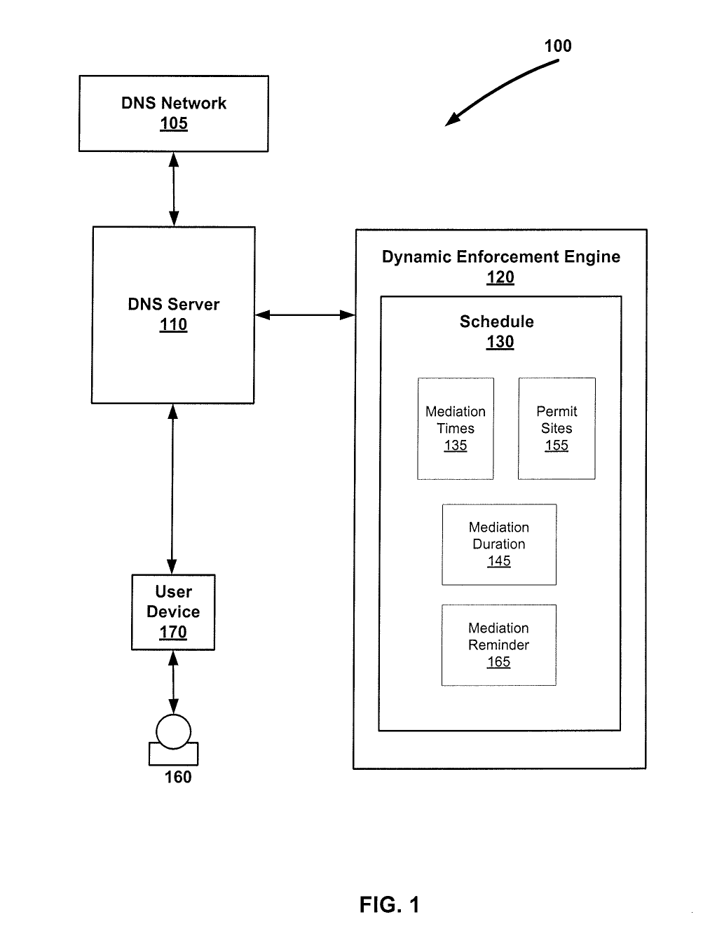

FIG. 1 illustrates system 100, an embodiment of the present invention. In system 100, a dynamic enforcement engine 120 is in communication with a DNS server 110. In various embodiments, DNS server 110 may be a server for providing Internet access, for example as maintained by an ISP. DNS server 110 is in communication with DNS network 105. In system 100, a user 160 may access Internet service over the DNS network 105, via the DNS server 110, by using a user device 170.

In various embodiments, the dynamic enforcement engine 120 may be provided by the DNS server 110, or separately and in communication therewith. User device 170 may be any device by which the user may access the Internet, such as a personal computer or mobile device. User 160 may use the user device 170 to specify an schedules 130, for example by entering schedules data. For example, as a part of the schedules 130, user 160 may specify a schedule for mediating Internet service by specifying mediation times 135. As a part of the schedules 130, user 160 may further specify a mediation duration 145 for controlling the period over which the mediation is to be maintained. The mediation duration 145 specifies how long a mediation session will last, for example for a period of time between 10 minutes and 24 hours, more particularly between 1 and 8 hours, for example 4 hours.

As a part of the schedules 130, user 160 may further specify permit sites 155 to which access will be allowed during a mediation duration 145. The user 160 may specify permit sites 155 to which access is retained during a mediation duration 145, for example to allow access to sites which may be enjoyed together with the user's friends, family, partner, children or others. Permit sites 155 may include any site or sites to which the user 160 would like to retain access, for instance music sites such as Pandora or iTunes, or movie sites such as Netflix.

In various embodiments, the user 160 cannot set or change the mediation duration 145, the user 160 may only specify the mediation duration 145 prior to a period of mediated service but cannot modify the mediation duration 145 while the mediation duration 145 is in effect, or may modify it at any time. In embodiments in which users 160 do not have the ability to specify a mediation duration 145, the system may automatically mediate Internet access for a preset duration. After that time, the Internet resolution will be restored. In such embodiments, the preset duration may encourage users to spend a significant amount of quality time together, for example to ensure that a potential evening planned at home is not interrupted. In various embodiments of the present invention, a mediation time 135 may have a default mediation duration 145. A default mediation duration 145 may be several hours, such as 4 hours. Some embodiments of the present invention may offer users 160 the ability to cancel an active mediation session, for example in cases in which the interpersonal commitment has unexpectedly ended for some reason and the user 160 would like to resume Internet access, or when a user 160 needs to access the Internet urgently despite a scheduled interpersonal commitment, for example to read an urgent email.

In various embodiments, user 160 may specify a mediation reminder 165 as a part of the schedules 130. The mediation reminder 165 may trigger the system 100 to provide a simple reminder or notification to a user 160 of a scheduled interpersonal commitment without effecting any actual network intervention. In some embodiments of the present invention, notifications may comprise messages that are sent to the user on a user device, such as user device 170, for example via pop-ups, chat messages, or other audio or visual cues to remind a user 160 of the occurrence of an interpersonal commitment. Embodiments of the system may also provide mediation reminders 165 via external means, instead of, or in addition to, reminders presented on the user device 170, which may serve as the user's primary access channel to the Internet. For example, mediation reminders 165 can be sent externally such as via email or SMS text. A user 160 may designate that mediation reminders 165 be sent via several channels concurrently, for example to incorporate a redundancy to the notification scheme to ensure that the mediation reminder 165 is successfully received.

In some embodiments, systems of the present technology may keep track of mediation activity for a user's account. For example, the system may record the aggregate number of mediated sessions, mediation duration, mediated durations that were canceled or aborted, and other data. Embodiments of the system may present recorded data to a user 160, such as in a reporting log associated with the user's account and accessible to the user 160, for example through a user interface.

Embodiments of the present technology do not require that any data be stored to employ them properly. In some embodiments of the present technology, no personal data on identity or Internet behavior is collected, nor are any alerts, notifications, or reporting log events generated. In such embodiments, no personal identifiable information is collected or stored by any component, such as the dynamic enforcement engine, user interface, network cloud, DNS network, DNS server, or ISP. In other embodiments, only aggregated and anonymous data may be collected, maintained, and analyzed, for example to determine the effectiveness of a service. In such embodiments, the data collected includes no specific information, for example the name or address of individual sites that were blocked or mediated is not recorded.

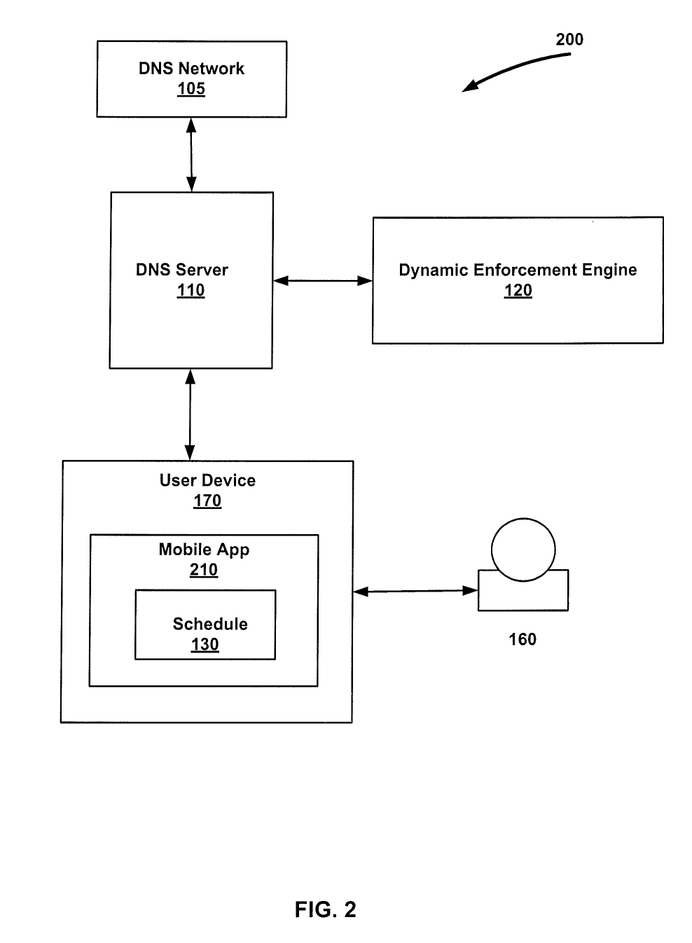

FIG. 2 illustrates system 200, an embodiment of a system of the present invention. System 200 provides Internet mediation functionality on an Internet-enabled mobile device, user device 170. In system 200, the user device 170 is a mobile device, such as a smartphone. User device 170 is equipped with a mobile software application, mobile app 210. Mobile app 210 operates on the mobile device's operating system and provides a user interface through which the user 160 may enter schedule data to define a schedule 130. The schedule 130 is then stored in the user device 170. Schedule data entered by the user 160 may include one or more schedules of mediation times, durations, reminders, and access sites.

When a mediation time occurs, the mobile app 210 sends a trigger instruction to a dynamic enforcement engine 120. The trigger instruction instructs the dynamic enforcement engine 120 to command the DNS server 110 to mediate Internet access to the user device 170 in accordance with the schedule 130. When a mediation duration as specified in the schedule 130 elapses, the mobile app 210 sends a cease instruction to the dynamic enforcement engine 120, instructing the dynamic enforcement engine 120 to command the DNS server 110 to resume provision of unmediated Internet access to the user device 170.

In various embodiments, during a period of mediation of Internet access to a mobile device such as a smartphone, voice access will not be restricted, but only broadband data access will be restricted. This will enable the user 160 to continue to receive or make voice calls, such as emergency calls during the mediation duration. In other embodiments, all service may be mediated during the mediation duration, including voice and data service. Embodiments of the present invention may maintain some level of Internet service and access to the server or DNS server level even during a mediation duration, for example in order to allow users to control the provision of the service. For instance, service access may be maintained to the extent required to allow the user to disable the mediation functionality.

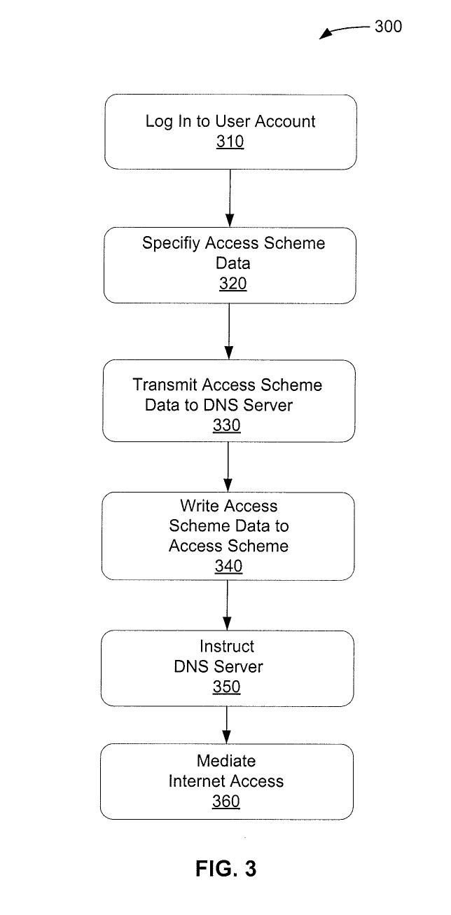

FIG. 3 illustrates an exemplary method 300, an embodiment of a method of using system 100 of FIG. 1. In method 300, system 100 operates automatically to mediate Internet access according to the mediation scheme, irrespective of whether the user actually initiates any requests for Internet access. In method 300, a user accesses a user interface on a user device, and logs in 310 to his or her user account. In some embodiments, the user logs in 310 to his or her account by supplying credentials, such as a user name and a password. The user account may be an Internet service account, for example as established with the user's ISP. In various embodiments, the user interface may be a graphical user interface, such as a webpage, having fields into which the user may specify 320 schedule data. The user may configure the schedule in several ways. For example, the user may configure the schedule to block Internet access entirely for the mediation duration or to allow access to one or more permit sites.

Once the user has entered the schedule data, the user may instruct the user interface to transmit 330 the schedule data to the DNS server. The user interface may transmit the schedule data to the dynamic enforcement engine. The dynamic enforcement engine may write 340 the schedule data to the schedule. When a designated mediation time arrives, the dynamic enforcement engine, with reference to the schedule, may instruct 350 the DNS server to mediate 360 Internet service access between user and a DNS network for the mediation duration.

For example, in various embodiments, in mediating 360 Internet service, the system 100 may block all Internet access, restrict Internet access only to particular sites, re-direct a user request to resolve an address, display a countdown timer until the mediation will lapse, direct the user request to the user's home page, allow the user request, re-direct the user request to an enable/disable page, and any combination thereof. In some embodiments, redirection may be performed very rapidly, for example so rapidly so as to not manifest any discernable delay to the user. Some embodiments perform redirection as necessary with less than a one millisecond delay to the network performance.

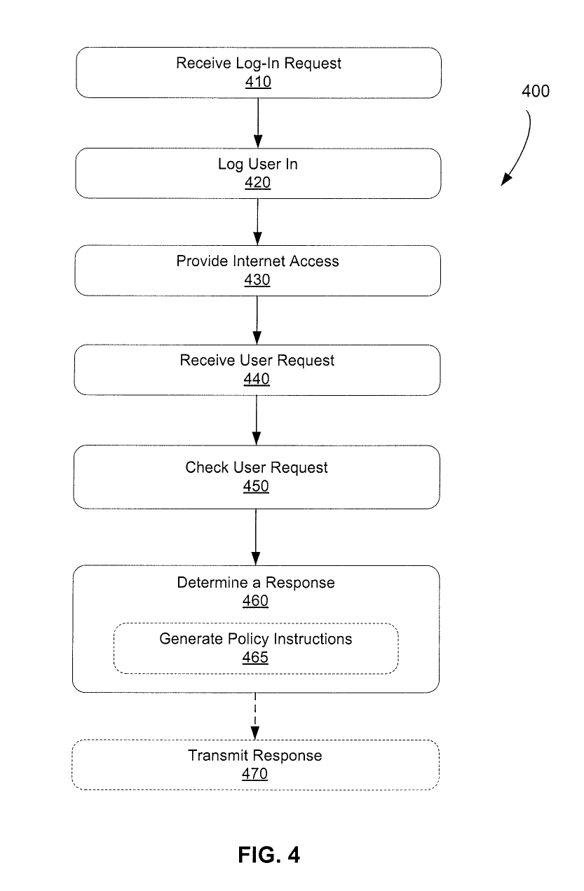

FIG. 4 provides a flow chart of an exemplary method 400 for using one or more systems of the present invention as described herein. Method 400 operates to determine and apply mediation in response to a user request to resolve an Internet address. Method 400 is performed by a network communication system for provisioning access to the Internet. In method 400, the system receives 410 a valid log-in request from a user to log-in to a user account associated with the user, for example a user account to provide Internet service over the network communication system such as provided by an ISP. In some embodiments, a valid log-in request comprises valid credentials supplied by the user, such as a valid user name and password. In response, the system logs the user in 420 to the system and provides 430 Internet access over the network communication system to the user under the user's account.

The system receives 440 a user request over the network communication system from the user, for example a user request to resolve an Internet address from a user interface operating on a user device. The system checks 450 the user request against a schedule, for example to determine if the user request is occurring during a scheduled period of mediation. When the system determines that the user request occurs during a scheduled period of mediated access, the system applies a schedule to the user request to determine 460 how to mediate service to the user.

When the system receives the user request during a mediation duration, determining 460 a response includes checking the user request against the schedule to see if the user request is for a permit site to which access is permitted during a mediation duration. Determining 460 a response may optionally include generating 465 policy instructions, for example to be executed by a DNS server on the network communication system. The system optionally transmits 470 any mediated service response to the user. In some embodiments, the system may provide no response to a user request during the pendency of a mediation duration. In other embodiments, the response may take various forms depending on the schedule.

For example, in response to a user request during a mediation duration, some embodiments of the present invention may provide a landing page. The landing page may be hosted on the network communication system, such as on the DNS server, or hosted by the user's ISP. In various embodiments, the landing page may comprise a terminal page that will not permit users to access any other website. In other embodiments, the disclosed Internet utilities may present a user with a landing page that will not permit a user to continue to the site that they were previously trying to access, but will allow the user to continue to another, innocuous or uninteresting site, such as a simple information page with no links to further sites. For instance, such a block page may comprise a home page where a user may merely review information such as current time, weather, or traffic data or news headlines, but without the ability to navigate beyond that page.

During mediation, embodiments of the present invention may not allow a user to initiate any new Internet browsing sessions, but may instead provide the user with access to a page or link to disable the mediation functionality, if desired. Some embodiments may further require entry of valid user credentials, such as a password, to modify the mediation functionality. The credentials may be set by the user but the system may require the user to enter the credentials before disabling or otherwise changing mediation functionality. In such embodiments, this requirement may provide a desired disincentive for a user to disable the mediation functionality during the active or enabled period.

Various embodiments of the present invention may also provide a landing page in the form of an intermediary page that allows a user to bypass a blocked service message and continue to his or her intended site. Some embodiments may require the user to read a warning or “cool down” message prior to bypassing a blocked service message. The warning or cool down message may be configured to apprise the user of the possible consequences of aborting a period of mediation which he or she had previously scheduled, and may further require the user to confirm a choice to bypass by clicking on an additional “are you sure” link after reading the warning or cool down message. In some embodiments, an intermediary page may be presented as a composite of the user's intended site and some additional content provided by the system. In some embodiments, the intermediary page may be an ISP branded page or the user's homepage.

In various embodiments, a landing page may include a “learn more” link that allows the use to access more detailed information about the mediation. The learn more link may point to another page at which users can discover more about the mediation utility's functionality and configuration capabilities. In some embodiments, the learn more link will point to a glossary page showing various information about the mediation utility, for example, a formal and technical description of the utility.

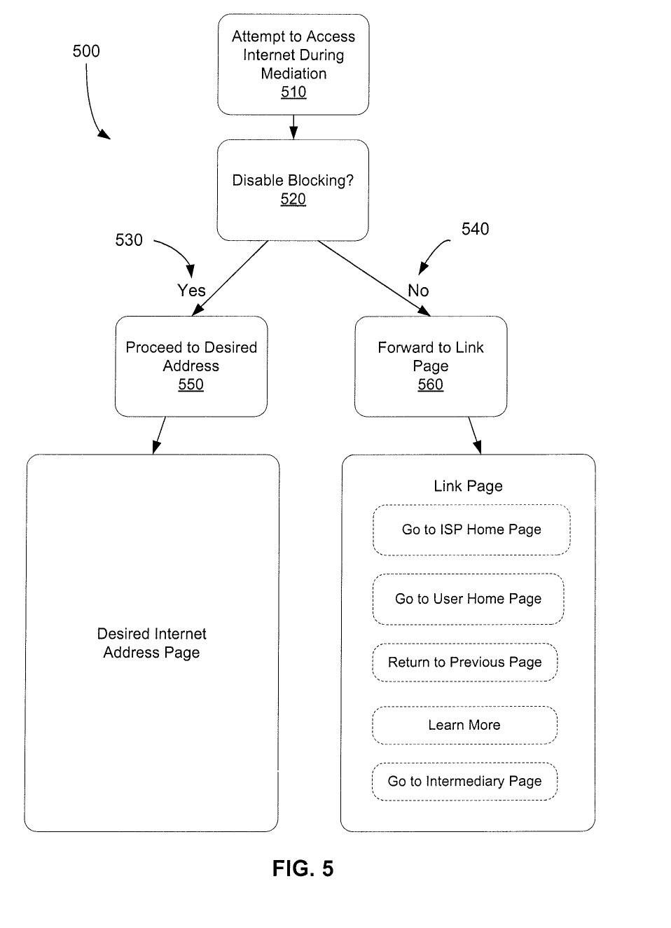

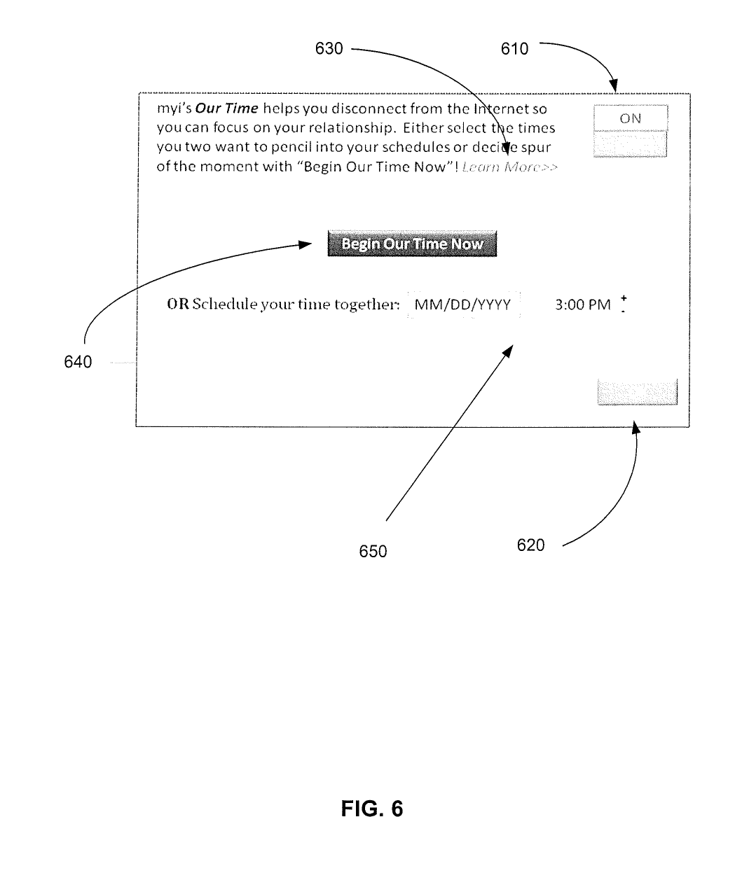

FIG. 5 illustrates a blocked site scheme 500. When a user attempts 510 to access the Internet during a period of blocked service, blocked site scheme 500 presents the user with an on/off webpage enabling the user to decide 520 whether to disable the mediation functionality. (An embodiment of an on/off webpage is presented in FIG. 6, addressed below.) If the user decides to disable 530 blocking, the user is allowed to resolve the desired Internet address and proceed 550 to the desired address. If the user decides not to disable 540 the mediation functionality of the embodiment, for example by selecting a “no” link, the user is forwarded 560 to a link page by the blocked site scheme 500. The link page may optionally present some, all, or none of the various options to the user as are addressed herein.

In various embodiments, the user is presented the option of disabling the mediation functionality for only this one instance of access, for all instances of access to the requested Internet address during the pending blocked period, or for all Internet sites for the pending blocked period. Embodiments of the present invention may have default settings. A default setting may be either enabled or disabled in various embodiments.

FIG. 6 illustrates an embodiment of an on/off webpage 600 of the present invention that may be displayed to users to enable the user to turn the mediation functionality on or off, or to enable or disable the functionality. In various embodiments, a user's decision to either enable or disable the functionality will take effect immediately, or alternatively within seconds, such as within 10 seconds or within 60 seconds of the user confirming his or her selection. When mediation is enabled, the mediation functionality will take effect at the next scheduled mediation time. When mediation is disabled, no mediation will occur when the next scheduled mediation time arrives.

On/off webpage 600 presents users with links, including on/off buttons 610 which the user may use to indicate his or her choice, and optionally a confirmatory link 620 to give effect to the user's selection. Further, on/off webpage 600 provides a learn more link 630 which the user may follow to be taken to a page displaying more information about the mediation system, for example the content blocked, why he or she encountered the page, and advantages and disadvantages of enabling or disabling the functionality.

On/off webpage 600 further includes a “begin now” button 640 to enable a user to elect for immediate mediation, for example on a whim or as an appropriate, unplanned interpersonal situation arises during which the user desires to be free from interruption or distraction. On/off webpage 600 allows a user to schedule a mediation time in the future by time and date via a scheduling field 650. When mediation is enabled, a mediated session will begin at the scheduled time. In some embodiments, a user will be required to enter credentials, such as a password or username, in order to change the status of the system from enabled to disabled or vice versa.

In various embodiments, learn more link 630 may provide the user with further information including all or some of the following: the user's attempt to access the site has been denied, the block was the result of a service affiliated with the user's ISP, information regarding, or a link to learn more about, why his or her website request was blocked, and the identity of the user who requested that this action be taken.

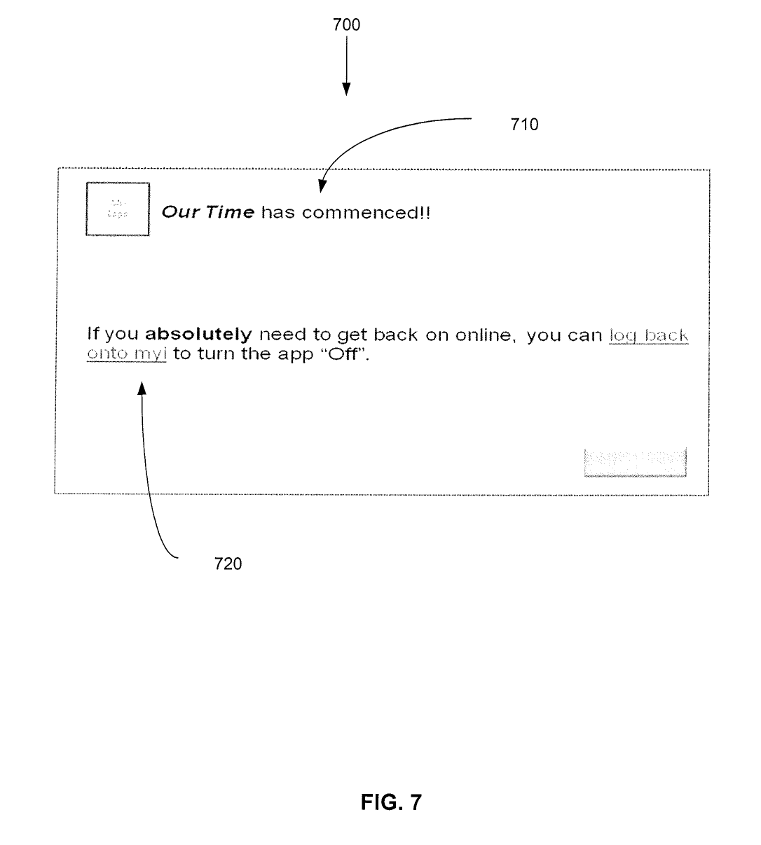

In some embodiments of the disclosed systems, when a user, or anyone using an Internet service under a user account for which mediation has been enabled, attempts to access the Internet during a mediation duration, the system may show a terminal page. FIG. 7 illustrates terminal page 700. Terminal page 700 may present a message communicating that mediation is presently effective and that therefore, access to the Internet is blocked or restricted, such as block message 710. In various embodiments, users will not be allowed to bypass block message 710. In some embodiments of terminal pages, such as in terminal page 700, the system offers the user the ability to disable the mediation by via an on/off page link 720. On/off link 720 may forward the user to an on/off page, such as on/off page 600 of FIG. 6. Some embodiments may require that a user provide access credentials, such as a password or user name, in order to access the on/off page.

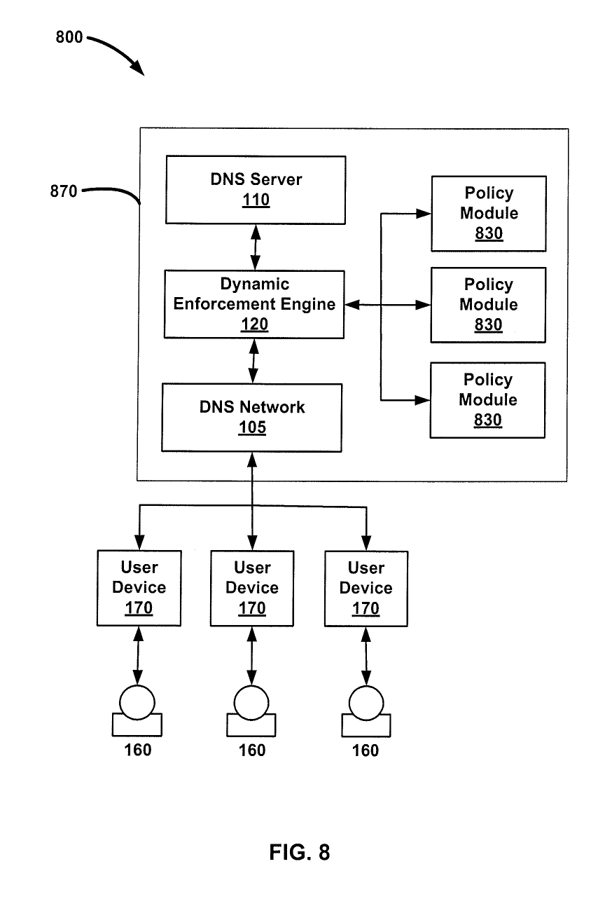

FIG. 8 illustrates an exemplary Internet service system 800, with a DNS server 110, that may be utilized to support the above described systems and methods. DNS server 110 operates in conjunction with a dynamic enforcement engine 120. The dynamic enforcement engine 120 may operate in conjunction with one or more policy modules 830 to establish any applicable polices at the DNS level. The dynamic enforcement engine 120 applies content rules to received user queries, and determines the content that is delivered by DNS network 105 through various user devices 170 to the users 160.

The dynamic enforcement engine 120 may generate its enforcement engine on instructions received from one or more policy modules 830. Each policy module 830 may be constructed to provide various types and levels of services to the DNS network 105. In various embodiments, a policy module 830 may be configured to handle queries directed to subjects including, but not limited to, malicious domain redirection, user access redirection, non-existent domain redirection, and data collection or analysis.

It will be recognized by those skilled in the art that the elements of DNS service 870 may be hosted either locally or remotely. In addition to residing in the DNS service 870, one or more of the DNS network 105, the dynamic enforcement engine 120, and the policy modules 830, and any combination thereof, may be resident on one or more user devices 170.

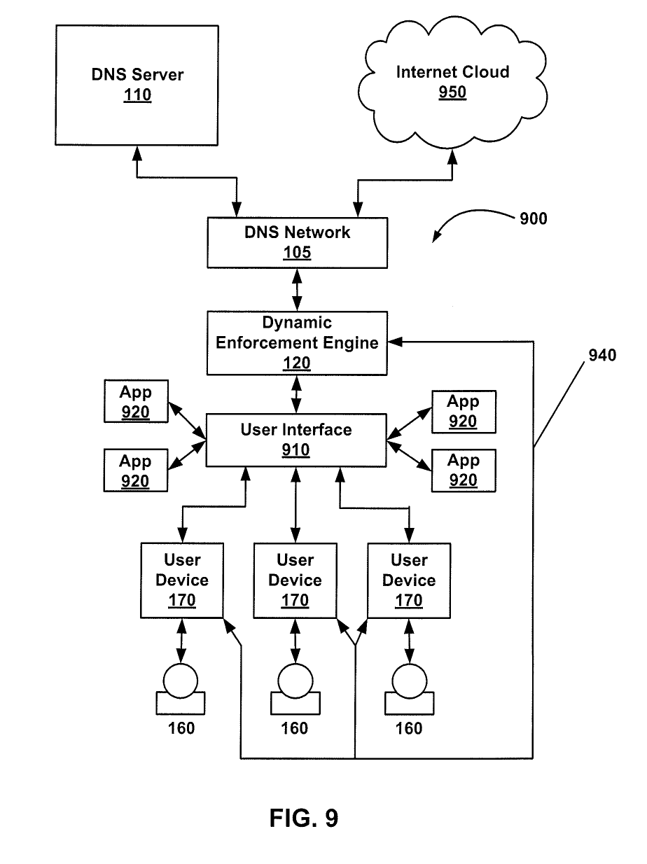

FIG. 9 shows a schematic layout of an exemplary system 900 for implementing direct and variable user control. FIG. 9 illustrates that the system 900 may operate installed on a DNS server 110, or with a cloud 950 based installation.

The system 900 utilizes a user interface 910. The user interface 910 may be implemented in many embodiments. One specific implementation of the user interface 910 is as a web page.

The user interface 910 may be accessed by one or more user devices 170 operated by the users 160. The user interface 910 may be accessed through a gateway user device 170 available to the users 160. Suitable user devices 170 include but are not limited to desktops, tablets, PCs, laptops, notebooks, gaming devices, iPods, automobile computer systems, and Internet enabled TVs. The system 900 may also be accessed and controlled remotely through user devices 170, such as a Smartphone mobile devices or other specialized Internet access devices such as a tablet. A Smartphone can be defined as a phone with computing capability. A Smartphone can provide the user 160 with Internet access.

The user interface 910 provides a mechanism for one or more authorized users 160 to establish content policy for the Internet service. The user interface 910 operates between the user devices 170 present in the system 900 and the DNS network 105. Instructions resident on the user interface 910 therefore operate on the Internet service, by controlling at least a portion of DNS resolutions via a dynamic enforcement engine 120, before the service reaches the displays of the user devices 170.

The user interface 910 provides the users 160 with access to one or more policy applications 920. The user interface 910 may provide access to a selection list to at least one authorized user 160. The authorized user 160 uses the selection list or some other menu mechanism to select those policy applications 920 that the user 160 chooses to apply to the system 900. The authorized user 160 may select any number of the available policy applications 920 for use on the system 900 at any given time. In implementations utilizing Smartphones as the user device 170, the policy applications 920 are downloaded to the device 170. The device 170 then serves as the user interface 910 to communicate directly with the dynamic enforcement engine 120.

The policy applications 920 may prohibit access to specific sites. The policy applications 920 may also limit the time of day when users or selected users 160 may access certain sites. The policy applications 920 may also manage and analyze duration of access to various sites. It is important to note that the policy applications 920 do not simply provide blocking mechanisms by masking or enabling network controls, but rather mediate an Internet service received by the user. The policy applications 920 may provide notifications or alerts to one or more users 160 when sites are accessed. The policy applications 920 may also provide notification of frequency and duration of access of designated sites. The policy applications 920 may also be used to observe, substitute, enable, redirect users, to reward behavior desired from the users by a system administrator, etc. The policy applications 920 may redirect users from a non-favored site to another site. The policy applications 920 may also collect and transmit data characteristic of Internet use.

Schedules supplied by the policy applications 920 may apply to all users 160 of the system 900, or the schedules may be specific to individual users or groups of users 160. The policy applications 920 may be discrete, single purpose applications.

The policy applications 920 provide the users 170 with a mechanism to take various actions relative to their Internet service feed. The policy applications 920 also allow the users 170 to establish a dynamic enforcement engine 120 that includes a user database. The dynamic enforcement engine 120 is used to enforce rules associated with each policy application associated with individual users, not simply block various inappropriate sites from the Internet feed. Rather, the dynamic enforcement engine 120, controlled by the user interface 910 through user device(s) 170, is used to manage all aspects of the Internet experience for the users 160. In sum, the policy applications 920 may be used to configure the dynamic enforcement engine 120 to provide the users 160 with a mechanism to personalize the Internet experience. The policy applications 920 may be configured in combinations, and may each be separately configured.

The database in the dynamic enforcement engine 120 may be used to record and to notify users 160 of various data relative to Internet access. The data collected from and provided to the users 160 may include records of access of specific sites, time spent on specific sites, time of day of access, data specific to individual users, etc.

It should also be noted that following an initial setup through the user interface 910 of the dynamic enforcement engine 120, a direct access 940 enforcement loop may be established between the dynamic enforcement engine 120 and the user devices 170. Subsequent accessing of the DNS network 105 utilizing the direct access 940 decreases response time in the system 900, thereby further enhancing the Internet experience of the users 160. Configurations of policy applications 920 that are selected by one or more users 160 designated as system administrators may remain in the user database of the dynamic enforcement engine 120 until such time as it can be modified by the system administrators. The system administrators may define multiple policy configurations, with a combination of policy applications 920, applicable to one or more users 160 of the system 900. Each policy application 920 may be separately configurable as well. Policy configurations may vary based upon designated times, conditional triggers, or specific requests from the users 160 with administrative authority.

As indicated above, two discrete data flow paths may be established for the system 900. A first data path establishes a set of enforcement policies for the system 900. The first data path flows from at least one user device 170 through the user interface 910, to the dynamic enforcement engine 120. A second data path 940 may be utilized following the establishment of a set of policies for the system 900. The second data path 940 flows directly between the user device(s) 170 and the dynamic enforcement engine 120. Multiple sets of enforcement policies may be established and saved within the system 900 and implemented selectively by the users 160.

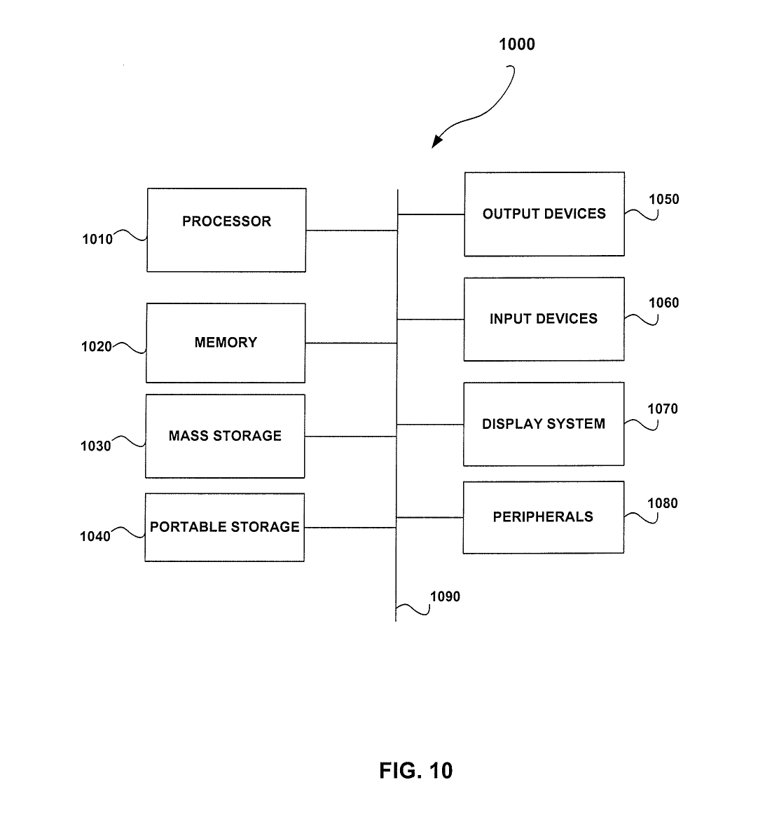

FIG. 10 illustrates an exemplary computing system 1000 that may be used to implement an embodiment of the present invention. System 1000 of FIG. 10 may be implemented in the context of user devices 170, DNS server 110, Internet cloud 950 and the like. The computing system 1000 of FIG. 10 includes one or more processors 1010 and memory 1020. Main memory 1020 stores, in part, instructions and data for execution by processor 1010. Main memory 1020 may store the executable code when the system 1000 is in operation. The system 1000 of FIG. 10 may further include a mass storage device 1030, portable storage medium drive(s) 1040, output devices 1050, user input devices 1060, a graphics display 1040, and other peripheral devices 1080.

The components shown in FIG. 10 are depicted as being connected via a single bus 1090. The components may be connected through one or more data transport means. Processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 may store the system software for implementing embodiments of the present invention for purposes of loading that software into main memory 1010.

Portable storage device 1040 operates in conjunction with a portable non-volatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Suitable output devices include speakers, printers, network interfaces, and monitors.

Display system 1070 may include a liquid crystal display (LCD) or other suitable display device. Display system 1070 receives textual and graphical information, and processes the information for output to the display device.

Peripherals 1080 may include any type of computer support device to add additional functionality to the computer system. Peripheral device(s) 1080 may include a modem or a router.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 may be a personal computer, hand held computing device, telephone, mobile computing device, workstation, server, minicomputer, mainframe computer, or any other computing device. The computer may also include different bus configurations, networked platforms, multi-processor platforms, etc. Various operating systems may be used including UNIX, Linux, Windows, Macintosh OS, Palm OS, and other suitable operating systems.

Some of the above-described functions may comprise instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

Any hardware platform suitable for performing the processing described herein is suitable for use with the invention. The terms “computer-readable storage medium” and “computer-readable storage media” as used herein refer to any medium or media that participate in providing instructions to a CPU for execution. Such media may take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media may also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer may read.

The systems and methods described above may typically be resident in an Internet service or a DNS network. For instance, although this description describes the technology in the context of a DNS server, it will be appreciated by those skilled in the art that an Internet service provider may be utilized with this invention instead or in conjunction with a DNS server. Functionalities and method steps that are performed by a DNS server may be performed by an Internet service provider. Furthermore, one skilled in the art will appreciate that the term “Internet content” comprises one or more web sites, domains, web pages, web addresses, one or more hyperlinks, URLs, any text, pictures, and/or media (such as video, audio, and any combination of audio and video) provided or displayed on a web page, and any combination thereof.

The systems and methods described may also be implemented in plug-in utilities, gateway devices, cable modems, proxy servers, set top boxes, and network interface devices. Further, as will be appreciated by those of ordinary skill in the art, the embodiments presented herein may be implemented on any form of Internet service, including, but not limited to, Broadband wireless access, including Mobile Communications (GSM) and Code Division Multiple Access (CDMA) systems, Cable Internet, Dial-up, ISDN, Modem, DSL, FTTH, Wi-Fi, DSL, Ethernet technologies, and SHDSL services, as well as others.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be accessed by an user device including but not limited to one or more of web sites, domains, web pages, web addresses, hyperlinks, URLs, any text, pictures, and/or media (such as video, audio, and any combination of audio and video) provided or displayed on a web page, and any combination thereof. Mediating the Internet service may include any of blocking, constraining, enabling, redirecting, promoting, demoting, substituting, obscuring, limiting, interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method of mediating Internet service to a user based on a schedule, comprising:
providing a user interface between a user and the Internet service to establish a schedule;
receiving the schedule via the user interface to apply to the Internet service;
receiving a request from a user to access Internet content; and
applying the schedule to the user request to access Internet content to determine whether access will be allowed.

2. The method of claim 1, wherein at least one element of the mediation policy is resident on the DNS server.

3. The method of claim 1, wherein at least one element of the mediation policy is enforced by the DNS server.

4. The method of claim 1, wherein providing a user interface between a user and the Internet service further comprises providing to the user a software application configured for installation on a user device.

5. The method of claim 1, wherein executing the policy instructions to mediate the Internet service to the user interface further comprises blocking Internet content.

6. The method of claim 1, wherein at least one element of the Internet service is resident on a user device.

7. The method of claim 1, wherein access to certain Internet content is allowed for shared entertainment purposes during scheduled times of restricted access.

8. The method of claim 1 wherein providing a user interface between a user and the Internet service further comprises providing to the user a software application configured for installation on a user device and further comprising transmitting the policy instructions to the Internet Service.

9. The method of claim 1, wherein the administrator determines specific mediation policies for different locations.

10. The method of claim 1, wherein the mediation policy allows for access to specified categories of permissible Internet content.

11. The method of claim 1, wherein the mediation policy remains in effect for a predetermined period of time.

12. The method of claim 1, wherein the mediation policy is established by more than one user.

13. The method of claim 1, wherein the mediation policy only applies to at least two users of the Internet service.

14. The method of claim 1, wherein a notification message is presented to the user in place of the restricted Internet content the user was attempting to access.

15. The method of claim 1, wherein executing the policy instructions to mediate the Internet service to the user comprises blocking at least a portion of a resolution performed by a Domain Name System (DNS) server.

16. The method of claim 1, wherein executing the policy instructions to mediate the Internet service to the user comprises redirecting at least a portion of a resolution performed by a Domain Name System (DNS) server.

17. A system for mediating Internet access to a user based on a schedule of mediation times, comprising:
an Internet service coupled to a network;
a user account associated with the user, the user account configured to provide the user with Internet access through the Internet service;
an schedule associated with the user account, the schedule being definable by the user and coupled to the Internet service; and
a dynamic enforcement engine in communication with the Internet service and configured to apply the schedule to direct the Internet service to mediate Internet access under the user account to determine whether access will be allowed.

18. The system of claim 17, wherein the schedule includes mediation times during which Internet access under the user account is to be mediated.

19. The system of claim 17, wherein the schedule includes data regarding Internet sites to which access under the user account will be allowed during the mediating Internet access.

20. The system of claim 17, wherein the schedule includes mediation times during which Internet access under the user account is to be mediated, and further includes a duration for the mediating Internet access, the duration being associated with the mediation times.

21. The system of claim 17, wherein the dynamic enforcement engine is further configured to generate policy instructions directing the Internet service to transmit a reminder to the user.

22. The system of claim 17, wherein the schedule cannot be modified under the user account during the mediating Internet access.

23. The system of claim 17, wherein the dynamic enforcement engine is further configured to record data associated with the user's use of the system.

24. The system of claim 17, wherein the dynamic enforcement engine is configured to apply the schedule to direct the Internet service to mediate Internet access under the user account, in response to a user request from the user to resolve an Internet address.

25. The system of claim 17, wherein the dynamic enforcement engine is resident on a computer processing device associated with the user.

26. The system of claim 17, wherein executing the policy instructions to mediate the Internet service to the user interface comprises blocking at least a portion of a resolution performed by the Internet service.

27. The system of claim 17, wherein executing the policy instructions to mediate the Internet service to the user interface comprises redirecting at least a portion of a resolution performed by the Internet service.

28. The system of claim 17, wherein applying the schedule to the user request to resolve an Internet address comprises allowing at least a portion of a resolution to be performed by a the Internet service.

29. The system of claim 17, wherein at least one element of the mediation policy is resident on a DNS server.

30. The system of claim 17, wherein at least one element of the mediation policy is enforced by a DNS Server.

31. A method of mediating Internet service based on a schedule via a DNS server, comprising:
providing a user interface between a user and the Internet service server to establish a schedule;
receiving the schedule via the user interface to configure a mediation policy in the DNS server;
receiving the user request to access Internet content from the user; and
applying the schedule based mediation policy to the user request to access Internet content.

32. The method of claim 31, wherein providing a user interface between a user and the Internet service via a DNS server further comprises providing to the user a software application configured for installation on a user device.

33. The method of claim 31, wherein executing the policy instructions to mediate the Internet service to the user interface further comprises blocking Internet content.

34. The method of claim 31, wherein the mediation policy allows access during restricted times to certain Internet content for entertainment purposes.

35. The method of claim 31, wherein the mediation policy allows for access to specified categories of permissible Internet content.

36. The method of claim 31, wherein the mediation policy remains in effect for a predetermined period of time.

37. The method of claim 31, wherein the mediation policy is established by more than one user.

38. The method of claim 31, wherein the mediation policy applies to at least two users of the Internet service.

39. The method of claim 31, wherein a notification message is sent to the user in place of the restricted Internet content the user was attempting to access.

40. The method of claim 31, wherein executing the policy instructions to mediate the Internet service comprises blocking at least a portion of a resolution performed by a Domain Name System (DNS) server.

41. The method of claim 31, wherein executing the policy instructions to mediate the Internet service interface comprises redirecting at least a portion of a resolution performed by a Domain Name System (DNS) server.

42. The method of claim 31, wherein applying the mediation policy to the user request to resolve an Internet content request comprises allowing at least a portion of a resolution to be performed by a Domain Name System (DNS) server.

43. The method of claim 31, wherein an administrator sets different mediation policies for different locations.

44. The method of claim 31, wherein a portion of the Internet service resides on a user device.

45. A system for mediating Internet access to a user based on a schedule of mediation times, comprising:
a Domain Name System (DNS) server coupled to a network;
a user account associated with the user, the user account configured to provide the user with Internet access through the DNS server;
a schedule associated with the user account, the schedule being definable by the user and coupled to the DNS server; and
a dynamic enforcement engine in communication with the DNS server and configured to apply the schedule to direct the DNS server to mediate Internet access under the user account.

46. The system of claim 45, wherein the schedule includes mediation times during which Internet access under the user account is to be mediated.

47. The system of claim 45, wherein the schedule includes data regarding Internet sites to which access under the user account will be allowed during the mediating Internet access.

48. The system of claim 45, wherein the schedule includes mediation times during which Internet access under the user account is to be mediated, and further includes a duration for the mediating Internet access, the duration being associated with the mediation times.

49. The system of claim 45, wherein the dynamic enforcement engine is further configured to generate policy instructions directing the DNS server to transmit a reminder to the user.

50. The system of claim 45, wherein the schedule cannot be modified under the user account during mediated Internet access.

51. The system of claim 45, wherein the dynamic enforcement engine is further configured to record data associated with the user's use of the system.

52. The system of claim 45, wherein the dynamic enforcement engine is configured to apply the schedule to direct the DNS server to mediate Internet access under the user account, in response to a user request from the user to resolve an Internet address.

53. The system of claim 45, wherein the dynamic enforcement engine is resident on a computer processing device associated with the user, the computer processing device associated with the user having a DNS client configured to communicate with the DNS server over the network.

54. The system of claim 45, wherein executing the policy instructions to mediate the Internet service to the user interface comprises blocking at least a portion of a resolution performed by the DNS server.

55. The system of claim 45, wherein executing the policy instructions to mediate the Internet service to the user interface comprises redirecting at least a portion of a resolution performed by the DNS server.

56. The system of claim 45, wherein applying the schedule to the user request to resolve an Internet address comprises allowing at least a portion of a resolution performed by a the DNS server.

57. The system of claim 45, wherein at least a portion of the Internet service resides on a user device.

58. A non-transitory computer-readable medium including processor-executable instructions that, when executed by one or more processors, cause the one or more processors to execute a method of mediating access to the Internet by a user, the method comprising:
providing a user account to the user, the user account being associated with the provision of Internet access;
receiving schedule data from the user, the schedule data specifying conditions for the provision of Internet access under the user account;
writing the schedule data to a schedule resident on the computer-readable medium, the schedule being associated with the user account; and
executing the processor-executable instructions according to the schedule to mediate the provision of Internet access under the user account.
